(19) United States
(12) Patent Application Publication
(10) Pub. No.: US 2007/0217521 A1
(43) Pub. Date: Sep. 20, 2007

(54) Relay unit and storage medium having stored therein computer program

(75) Inventors: Atsuyoshi Koga, Fukuoka (JP); Toshinobu Tsunematsu, Fukuoka (JP); Kenji Kawano, Fukuoka (JP); Katsuichi Yamaji, Fukuoka (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/495,605

(22) Filed: Jul. 31, 2006

(30) Foreign Application Priority Data
Mar. 17, 2006 (JP) 2006-075439

(51) Int. Cl. H04B 14/04; H04L 23/02

(52) U.S. Cl. 375/242; 375/265

(57) ABSTRACT

A relay unit capable of avoiding the occurrence of simultaneous switching whatever data is received and thereby preventing malfunction of the device due to impulse noise, and a memory product having stored therein a computer program are provided. The relay unit includes a latch unit that temporarily stores converted parallel data; a determining unit that compares received data with subsequent data to be received subsequently and thereby determines whether to invert bits of data; and an inverting unit that invert bits of converted serial data. When the determining unit determines that bit-inverted parallel data is received as subsequent data, the determining unit transmits to the latch unit a signal instructing to prohibit from storing temporarily the received subsequent data and transmits to the inverting unit a signal instructing to invert bits of data.

### CROSS-REFERENCE TO RELATED APPLICATIONS

This non provisional application claims priority under 35 U.S.C. §119(a) on Patent Application No. 2006-075439 filed in Japan on Mar. 17, 2006, the entire contents of which are hereby incorporated by reference.

### BACKGROUND OF THE INVENTION

1. Field of the Invention

The present invention relates to a relay unit that avoids simultaneous switching of all signals on a plurality of buses present inside thereof and thereby prevents malfunction of the device, and a storage medium having stored therein a computer program.

2. Description of the Background Art

Many relay units are developed that relay, when data communication is performed between a plurality of devices, data from the devices through a plurality of ports and then relay the data to desired external devices. FIG. 1 is a block diagram showing the configuration of a conventional relay unit (see Japanese Patent Application Laid-Open No. 4-017422).

As shown in FIG. 1, the conventional relay unit receives, by a receive block 11, data from a plurality of external devices through a plurality of receive ports. In the receive block 11, the received data is scrambled by an encoding unit 111, whereby simultaneous switching of a plurality of parallel data units which are converted by a serial/parallel converting unit 112 is avoided. An internal logic unit 12 performs, for example, the process of determining whether to transfer the data or the process of adding or deleting the data according to a condition, and sends the data to a transmit block 13.

In the transmit block 13, a parallel/serial converting unit 132 terminates the parallel data units into a serial data unit and then a decoding unit 131 descrambles the serial data, whereby the descrambled data is transferred to external devices as transmit data.

By scrambling the received data by the encoding unit 111, the parallel data units converted by the serial/parallel converting unit 112 are less likely to become data of consecutive bit strings. Accordingly, simultaneous switching is less likely to occur and thus the possibility of concurrent reading and writing from/to a memory is reduced, making it possible to prevent malfunction of the device due to impulse noise caused by a sudden increase in current.

### BRIEF SUMMARY OF THE INVENTION

The present invention is made in view of the foregoing and other problems. An object of the present invention is, therefore, to provide a relay unit capable of avoiding the occurrence of simultaneous switching whatever data is received and thereby preventing malfunction of the device due to impulse noise, and a storage medium having stored therein a computer program.

To achieve the aforementioned object, a first aspect of the present invention is directed to a relay unit that encodes data received frame by frame, converts the encoded data into parallel data, performs a predetermined process on the converted parallel data, converts the parallel data into serial data having been subjected to the predetermined process, decodes the converted serial data, and transmits the decoded serial data to external devices, comprising: a latch unit that temporarily stores, frame by frame, converted parallel data; a determining unit that compares received data with subsequent data to be received subsequently and thereby determines whether to invert bits of data; and an inverting unit that invert bits of converted parallel data, wherein the determining unit comprises: means for determining whether data obtained by inverting bits of the received converted parallel data is received as subsequent data; means for transmitting, in case for determining that the data is received as subsequent data, a signal instructing to prohibit from storing temporarily the received subsequent data, to the latch unit; and means for transmitting to the inverting unit a signal instructing to invert bits of data.

A relay unit according to a second aspect of the present invention is such that in the first aspect the determining unit further comprises: means for determining whether data obtained by inverting bits of part of the received converted parallel data is received as subsequent data; means for transmitting, in case for determining that the data is received as subsequent data, a signal instructing to prohibit from storing temporarily the received subsequent data, to the latch unit; and means for transmitting to the inverting unit a signal instructing to invert a bit which has not been inverted and to prohibit from inverting other bits.

A relay unit according to a third aspect of the present invention is such that in the first or the second aspect the determining unit further comprises: means for temporarily storing the received converted parallel data and the subsequent converted parallel data.

A fourth aspect of the present invention is directed to a computer memory product having stored therein a computer program executable by a relay unit that encodes data received frame by frame, converts the encoded data into parallel data, performs a predetermined process on the parallel data, converts the parallel data into serial data having been subjected to the predetermined process, decodes the converted serial data, and transmits the decoded serial data to external devices. The computer program causes a computer to function as: temporarily storing, frame by frame, converted parallel data; and comparing received data with subsequent data to be received subsequently and thereby determining whether to invert bits of data. In addition, the computer program causes the determining unit to: determining whether data obtained by inverting bits of the received converted parallel data is received as subsequent data; and converting parallel data into serial data, in case for determining to be received as subsequent data, the received subsequent data without temporarily storing the received subsequent data and then invert bits of data.

A computer memory product having stored therein a computer program according to a fifth aspect is such that in the fourth aspect the computer program causes the determining unit to: determine whether data obtained by inverting bits of part of the received converted parallel data is received as subsequent data; and

transmit, in case for determining to be received as subsequent data, an instruction to convert the received subsequent data into parallel data without temporarily storing the received subsequent data and then to invert a bit which has not been inverted and to prohibit from inverting other bits.

In the first and the fourth aspects, data received frame by frame is encoded, the encoded data is converted into parallel data, the converted parallel data is subjected to a predetermined process, the parallel data having been subjected to the predetermined process is converted into serial data, the converted serial data is decoded, and the decoded serial data is transmitted to external devices. The converted parallel data is latched (temporarily stored) frame by frame and received data is compared with subsequent data to be received subsequently and thereby a determination as to whether to invert bits of data is made. When data obtained by inverting bits of the received converted parallel data is received as subsequent data, without latching the received subsequent data, the received data is reconstructed into serial data and then invert bits of the serial data. By this, when subsequent bit-inverted data is received, without all buses being switched simultaneously, it is sufficient to transmit to the transmit block only a signal instructing to invert bits of data, e.g., an inverse bit (1 bit), after a predetermined process is performed. Accordingly, without using a large amount of the memory, the received data can be transferred to external devices. In addition, since simultaneous switching does not occur and thus there is no possibility of concurrent reading and writing from/to the memory, malfunction of the device due to impulse noise caused by a sudden increase in current does not occur, making it possible to ensure stable operation of the device.

In the second and the fifth aspects, a determination as to whether data obtained by invert bits of part of the received converted parallel data is received as subsequent data. When the data is determined to be received as subsequent data, without latching the received subsequent data, a bit which has not been inverted is inverted and other bits are not inverted. By this, even when subsequent data, part of whose bits is inverted, is received, without many buses being switched simultaneously, it is sufficient to transmit to the transmit block a signal instructing to invert bits of data, e.g., a signal indicating a bit location not inverted, after a predetermined process is performed. Accordingly, while the amount of the memory used is reduced, the received data can be transferred to external devices. In addition, since there are only a few buses where the concurrent reading and writing from/to the memory occur, the increase in current can be reduced and malfunction of the device due to impulse noise does not occur, making it possible to ensure stable operation of the device.

In the third aspect, the received converted parallel data and the subsequent converted parallel data received subsequently are temporarily stored. This makes it possible to accurately grasp whether all bit strings are inverted, which bit is inverted, or the like.

According to the first and the fourth aspects, when subsequent bit-inverted data is received, without all buses being switched simultaneously, it is sufficient to transmit to the transmit block only a signal instructing to invert bits of data, e.g., an inverse bit (1 bit), after a predetermined process is performed. Accordingly, without using a large amount of the memory, the received data can be transferred to external devices. In addition, since simultaneous switching does not occur and thus there is no possibility of concurrent reading and writing from/to the memory, malfunction of the device due to impulse noise caused by a sudden increase in current does not occur, making it possible to ensure stable operation of the device.

According to the second and the fifth aspects even when subsequent data, part of whose bits is inverted, is received, without many buses being switched simultaneously, it is sufficient to transmit to the transmit block a signal instructing to invert bits of data, e.g., a signal indicating a bit location not inverted, after a predetermined process is performed. Accordingly, while the amount of the memory used is reduced, the received data can be transferred to external devices. In addition, since there are only a few buses where the concurrent reading and writing from/to the memory occur, the increase in current can be reduced and malfunction of the device due to impulse noise does not occur, making it possible to ensure stable operation of the device.

According to the third aspect, whether all bit strings are inverted, which bit is inverted, or the like can be accurately grasped.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing a configuration of a conventional relay unit;

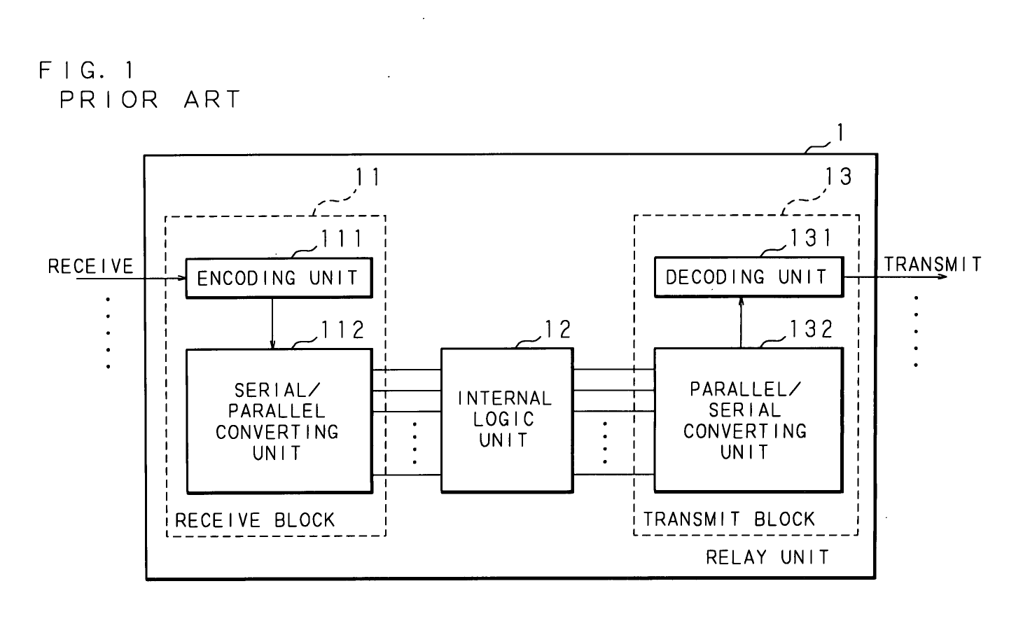

FIG. 2 is a block diagram showing a configuration of a relay unit according to a first embodiment of the present invention;

FIG. 3 is a block diagram showing a configuration of an encoding unit;

FIG. 4 is a block diagram showing a configuration of a decoding unit;

FIG. 5 is a block diagram showing a configuration of a determining unit;

FIG. 6 is a block diagram showing an operation of the relay unit performed when data P matches data Q;

FIG. 7 is a block diagram showing a configuration of a relay unit according to a second embodiment of the present invention, where data of an X frame is received;

FIG. 8 is a block diagram showing a configuration of a determining unit;

FIG. 9 is a block diagram showing an operation of the relay unit performed when data P matches data Q;

FIG. 10 is a block diagram showing a configuration of a microcomputer that composes a receive block of a relay unit according to a third embodiment of the present invention;

FIG. 11 is a block diagram showing a configuration of a microcomputer that composes a transmit block of the relay unit according to the third embodiment of the present invention;

FIG. 12 is a flowchart showing processing steps of a CPU of the microcomputer that composes the receive block of the relay unit according to the third embodiment of the present invention;

FIG. 13 is a flowchart showing processing steps of a CPU of the microcomputer that composes the transmit block of the relay unit according to the third embodiment of the present invention;

FIG. 14 is a flowchart showing processing steps of a CPU of a microcomputer that composes a receive block of a relay unit according to a fourth embodiment of the present invention; and

FIG. 15 is a flowchart showing processing steps of a CPU of a microcomputer that composes a transmit block of the relay unit according to the fourth embodiment of the present invention.

### DETAILED DESCRIPTION OF THE INVENTION

In the aforementioned conventional relay unit, received data is scrambled by the encoding unit 111 so that a plurality of parallel data units converted by the serial/parallel converting unit 112 become data of inconsecutive bit strings. However, since a scrambling algorithm is fixed, even if data is scrambled, the data may be outputted with bit strings being consecutive, depending on the received data. In this case, the number of bits that switch simultaneously increases; as a result, impulse noise is caused by a sudden increase in current which occurs when many reading and writing processes from/to a memory occur at the same time, leaving the possibility that the device may malfunction.

The present invention is made in view of the foregoing and other problems. An object of the present invention is, therefore, to provide a relay unit capable of avoiding the occurrence of simultaneous switching whatever data is received and thereby preventing malfunction of the device due to impulse noise, and a storage medium having stored therein a computer program. The present invention will be described in detail below with reference to the drawings showing embodiments thereof.

### First Embodiment

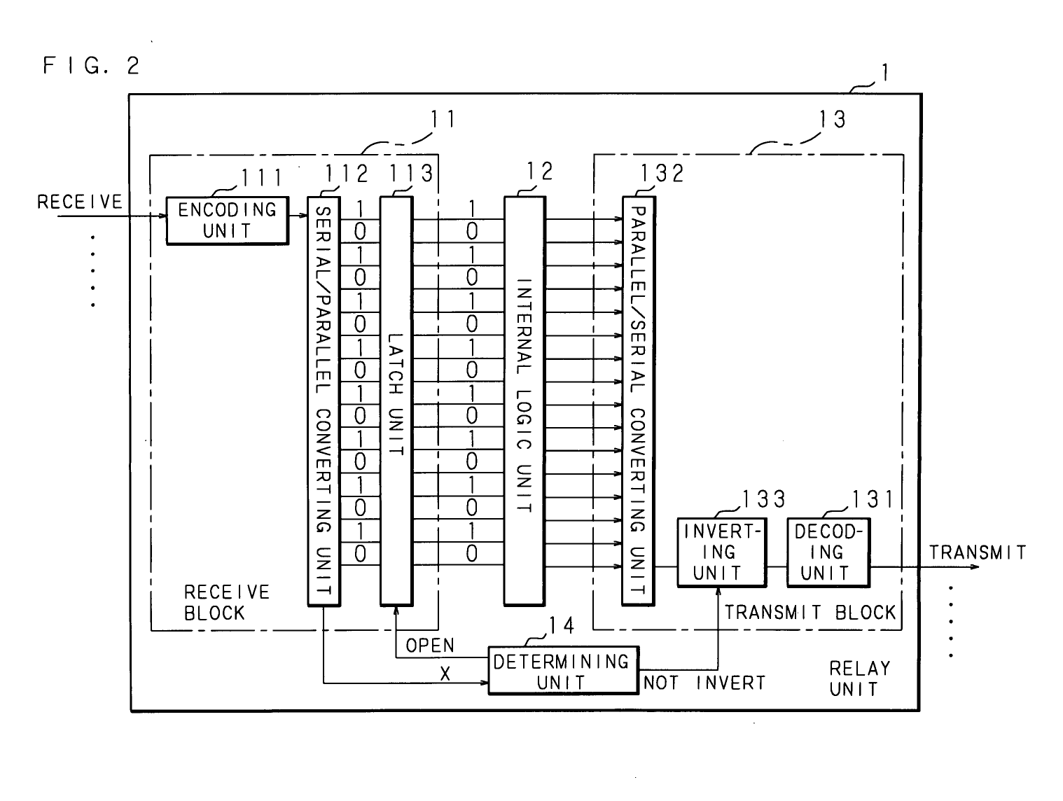

FIG. 2 is a block diagram showing the configuration of a relay unit 1 according to a first embodiment of the present invention. Note that although the first embodiment is described using an example in which the relay unit 1 has 16 buses (16 bits), the number of bus lines is not particularly limited and 8, 4, 32, or 64 buses may be used. As shown in FIG. 2, the relay unit 1 according to the first embodiment of the present invention includes a receive block 11 having a plurality of receive ports; an internal logic unit 12 that performs, for example, the process of determining whether to transfer data or the process of adding or deleting data according to a condition; a transmit block 13 having a plurality of transmit ports; and a determining unit 14 that monitors data to be received all the time and compares received data with subsequent data to be received subsequently and thereby determines whether to invert bits of data.

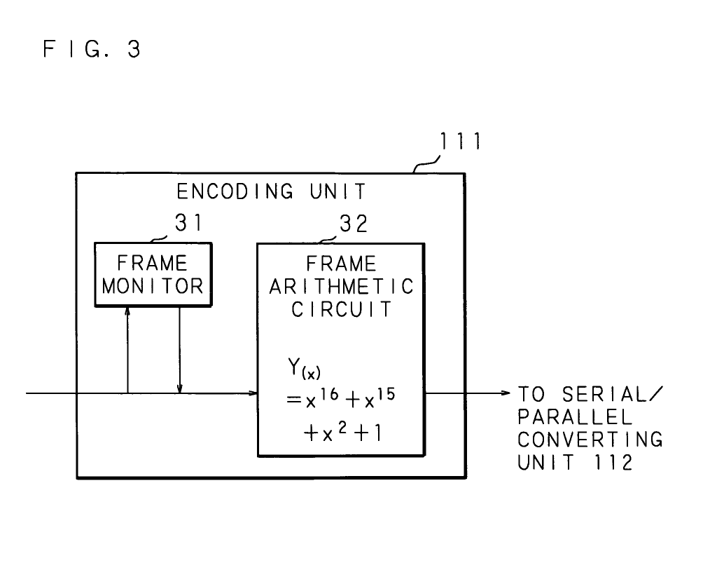

The receive bock 11 includes an encoding unit 111 that encodes (scrambles) data received frame by frame; a serial/parallel converting unit 112 that converts the encoded serial data into 16-bit parallel data; and a latch unit 113 that latches (temporarily stores) the converted parallel data. FIG. 3 is a block diagram showing the configuration of the encoding unit 111.

The encoding unit 111 includes at least a frame monitor 31 that detects the start and end of a frame; and a frame arithmetic circuit 32. The encoding unit 111 encodes, frame by frame, received data using a predetermined arithmetic polynomial. Specifically, when the frame monitor 31 detects the start of a frame, the frame arithmetic circuit 32 is enabled and encodes received data by the predetermined arithmetic polynomial. The arithmetic polynomial is not particularly limited and the data is encoded using, for example, expression 1 which is a CRC-16 generator polynomial.

Y(x)=x¹⁶+x¹⁵+x²+1 (expression 1)

When the frame monitor 31 detects the end of the frame, the frame arithmetic circuit 32 is disabled and does not perform an encoding process. The serial data processed by the encoding unit 111 is converted into parallel data by the serial/parallel converting unit 112 and the parallel data is transmitted to 16 buses as bit data.

In the first embodiment, the latch unit 113 is provided before the internal logic unit 12. The latch unit 113 temporarily stores (latches) the parallel data transmitted from the serial/parallel converting unit 112. When the latch unit 113 receives from the determining unit 14 a signal e.g., an “OPEN” signal, which instructs to transmit the latched parallel data from the latch unit 113, the latch unit 113 transmits the latched parallel data to the internal logic unit 12. When the latch unit 113 receives from the determining unit 14 a signal, e.g., a “CLOSE” signal, which instructs to prohibit from transmitting the latched parallel data from the latch unit 113, the latch unit 113 does not transmit the latched parallel data to the internal logic unit 12.

The internal logic unit 12 performs, for example, the process of determining whether to transfer the received data or the process of adding or deleting the data according to a predetermined condition. The parallel data processed by the internal logic unit 12 is transmitted to the transmit block-13.

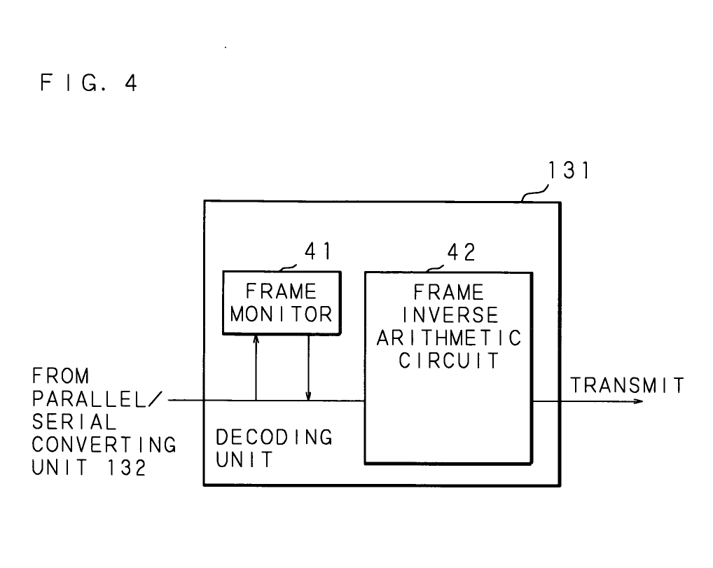

The transmit block 13 includes a parallel/serial converting unit 132 that terminates the encoded 16-bit parallel data into a serial data unit; a decoding unit 131 that decodes (descrambles) the encoded data; and an inverting unit 133 that inverts the serial data. FIG. 4 is a block diagram showing the configuration of the decoding unit 131.

The decoding unit 131 includes at least a frame monitor 41 that detects the start and end of a frame; and a frame inverse arithmetic circuit 42. The decoding unit 131 decodes, frame by frame, the encoded data using a predetermined inverse arithmetic polynomial. Specifically, when the frame monitor 41 detects the start of a frame, the frame inverse arithmetic circuit 42 is enabled and decodes received data by the predetermined inverse arithmetic polynomial. The inverse arithmetic polynomial is not particularly limited; when the data is encoded using, for example, expression 1 which is a CRC-16 generator polynomial, an inverse matrix T⁻¹(x) that satisfies expression 2 is obtained.

(x¹⁶+x¹⁵+x²+1)×T⁻¹(x)=1 (expression 2)

When the frame monitor 41 detects the end of the frame, the frame inverse arithmetic circuit 42 is disabled and does not perform a decoding process. The serial data processed by the decoding unit 131 is transmitted to external devices through the transmit ports.

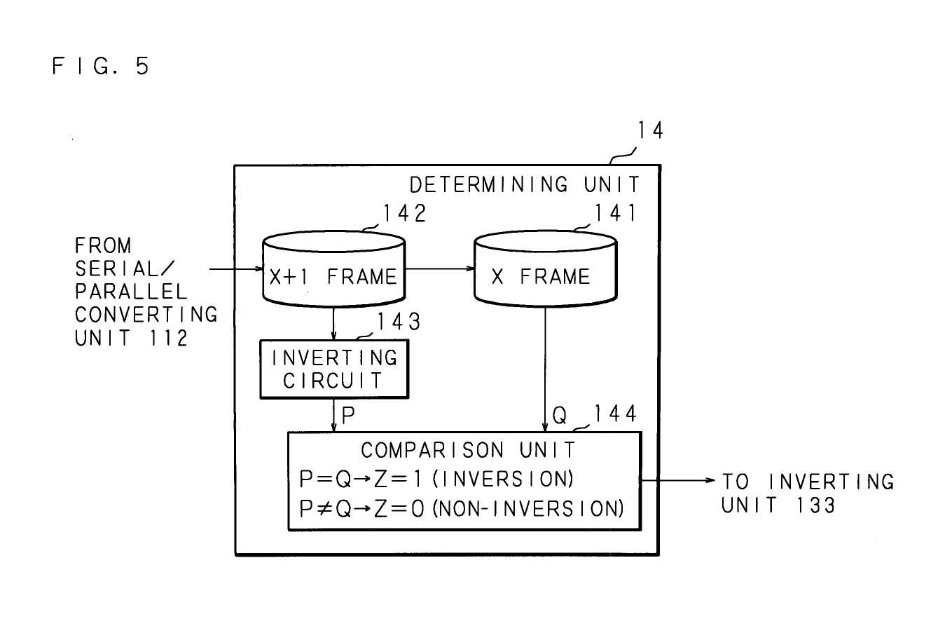

The determining unit 14 compares received data of an X frame with data of an X+1 frame and determines whether the data of the X frame matches data obtained by inverting bits of the subsequent data of the X+1 frame and then determines whether to transmit the data temporarily stored in the latch unit 113 and whether to invert bits of data in the inverting unit 133. FIG. 5 is a block diagram showing the configuration of the determining unit 14.

The determining unit 14 temporarily stores data Q of an X frame in a first memory 141. Then, the determining unit 14 receives subsequent data of an X+1 frame and temporarily stores the data of the X+1 frame in a second memory 142. Then, an inverting circuit 143 inverts bits of the data of the X+1 frame. A comparison circuit 144 determines whether data P obtained by inverting bits of data of the X+1 frame matches the data Q of the X frame. When the data P matches the data Q, the determining unit 14 transmits a “CLOSE” signal to the latch unit 113, sets an inverse bit Z to “1” which instructs to invert bits of data, and transmits the inverse bit Z of 1 to the inverting unit 133. Note that the data of the X frame and the data of the X+1 frame are not limited to ones to be temporarily stored in the determining unit 14.

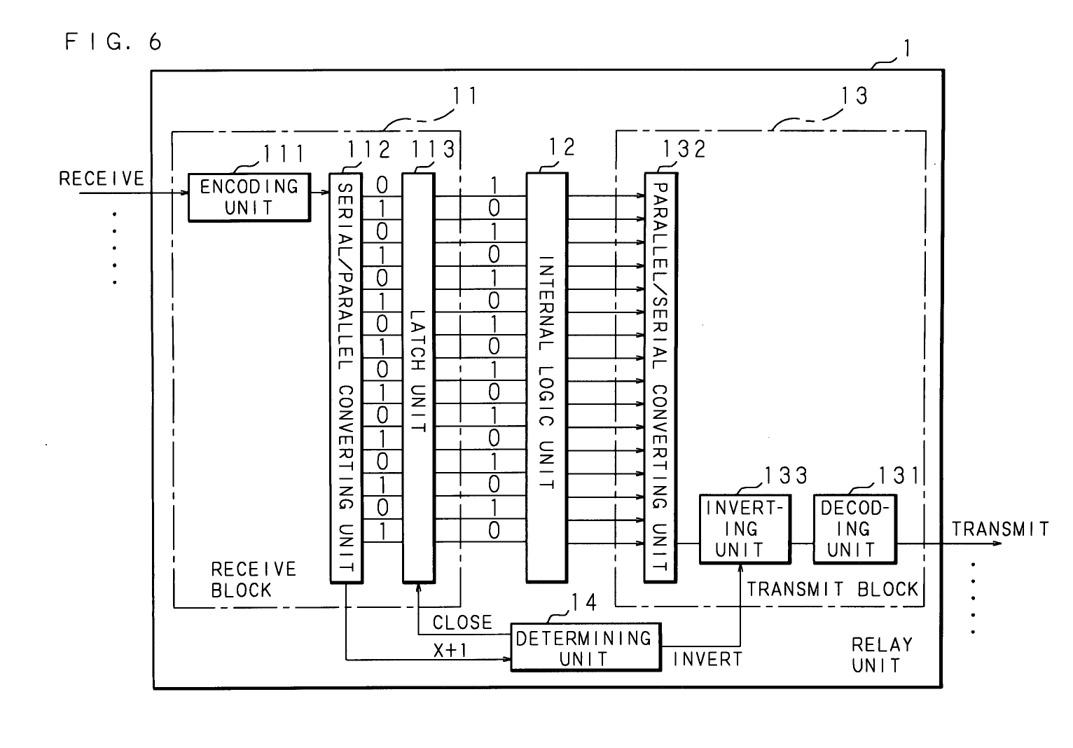

When the data P does not match the data Q, the determining unit 14 transmits an “OPEN” signal to the latch unit 113, sets the inverse bit Z to “0” which instructs to prohibit from inverting bits of data, and transmits the inverse bit Z of 0 to the inverting unit 133. FIG. 6 is a block diagram showing the operation of the relay unit 1 performed when the data P matches the data Q.

As shown in FIG. 6, when, while received data of the X frame is “5555”, received data of the X+1 frame is “AAAA”, the determining unit 14 determines that the data P matches the data Q. The determining unit 14 thus transmits a “CLOSE” signal to the latch unit 113, sets the inverse bit Z to “1” which instructs to invert bits of data, and transmits the inverse bit Z of 1 to the inverting unit 133. Accordingly, the received data of the X+1 frame is not transmitted to the internal logic unit 12 and the received data of the X frame is transmitted to the internal logic unit 12. After a predetermined arithmetic operation is performed on the data of the X frame, the data is terminated into serial data by the parallel/serial converting unit 132. The inverting unit 133 invert bits of the terminated serial data and the decoding unit 131 decodes the bit-inverted serial data and then transmits the decoded data to external devices.

As such, when it is verified, as a result of comparing received data of the X frame with received data of the X+1 frame, that all bits are inverted, without the occurrence of simultaneous switching, a process in the internal logic unit 12 is performed and only an inverse bit (1 bit) is transmitted to the inverting unit 133. Thus, without using a large amount of the memory, power consumption can be reduced.

As described above, according to the first embodiment, when subsequent data (data of the X+1 frame) subjected to a bit inversion is received, without all buses being switched simultaneously, it is sufficient to transmit to the transmit block 13 only a signal instructing to invert bits of data, e.g., an inverse bit (1 bit), after a predetermined process is performed. Accordingly, without using a large amount of the memory, the received data can be transferred to external devices. In addition, since simultaneous switching does not occur and thus there is no possibility of concurrent reading and writing from/to the memory, malfunction of the device due to impulse noise caused by a sudden increase in current does not occur, making it possible to ensure stable operation of the device.

### Second Embodiment

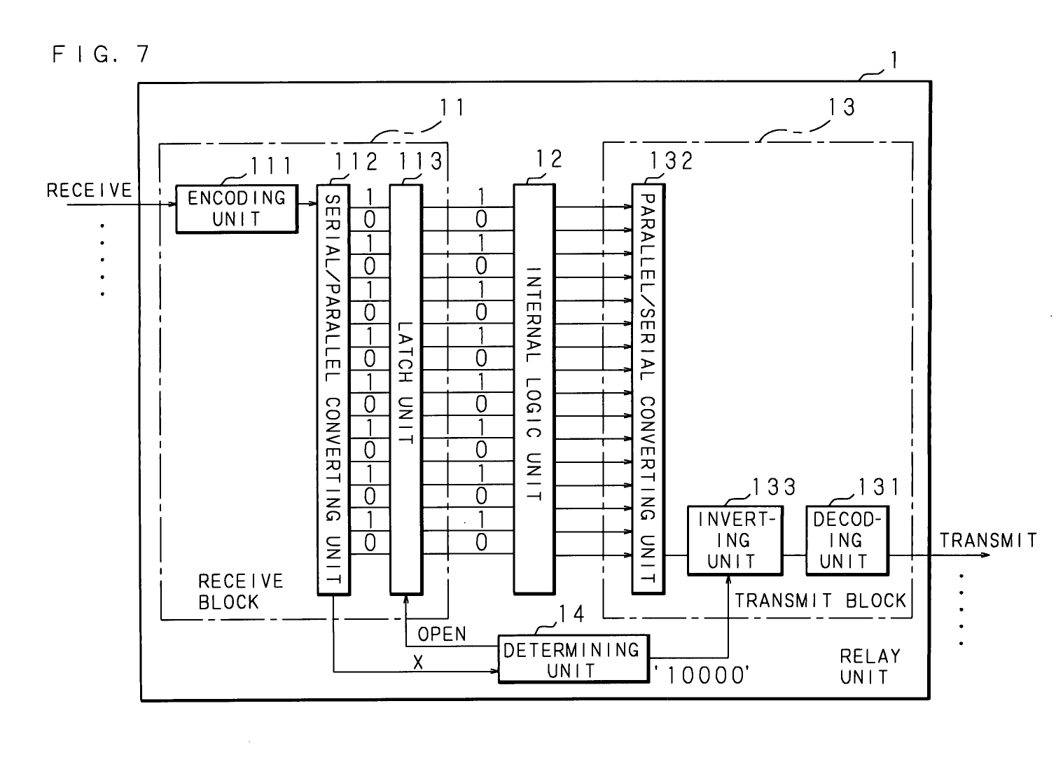

A relay unit 1 according to a second embodiment of the present invention will be described in detail below with reference to the drawings. FIG. 7 is a block diagram showing the configuration of the relay unit 1 according to the second embodiment of the present invention, where data of an X frame is received. Note that as with the first embodiment the second embodiment is also described using an example in which the relay unit 1 has 16 buses (16 bits); however, the number of bus lines is not particularly limited and 8, 4, 32, or 64 buses may be used. Note also that the parts having the same functions as those of the relay unit 1 according to the first embodiment are denoted by the same reference numerals and the detailed description thereof is omitted.

The receive block 11 includes the encoding unit 111 that encodes (scrambles) data received frame by frame; the serial/parallel converting unit 112 that converts the encoded serial data into 16-bit parallel data; and the latch unit 113 that latches (temporarily stores) the converted parallel data. The configuration of the encoding unit 111 is the same as that described in the first embodiment.

In the second embodiment, the latch unit 113 is provided before the internal logic unit 12. The latch unit 113 temporarily stores (latches) the parallel data transmitted from the serial/parallel converting unit 112. When the latch unit 113 receives from the determining unit 14 a signal, e.g., an “OPEN” signal, which instructs to transmit the latched parallel data from the latch unit 113, the latch unit 113 transmits the latched parallel data to the internal logic unit 12. When the latch unit 113 receives from the determining unit 14 a signal, e.g., a “CLOSE” signal, which instructs to prohibit from transmitting the latched parallel data from the latch unit 113, the latch unit 113 does not transmit the latched parallel data to the internal logic unit 12.

The internal logic unit 12 performs, for example, the process of determining whether to transfer the received data or the process of adding or deleting the data according to a predetermined condition. The parallel data processed by the internal logic unit 12 is transmitted to the transmit block 13.

The transmit block 13 includes the parallel/serial converting unit 132 that terminates the encoded 16-bit parallel data into a serial data unit; the decoding unit 131 that decodes (descrambles) the encoded data; and the inverting unit 133 that inverts the serial data. The configuration of the decoding unit 131 is the same as that described in the first embodiment.

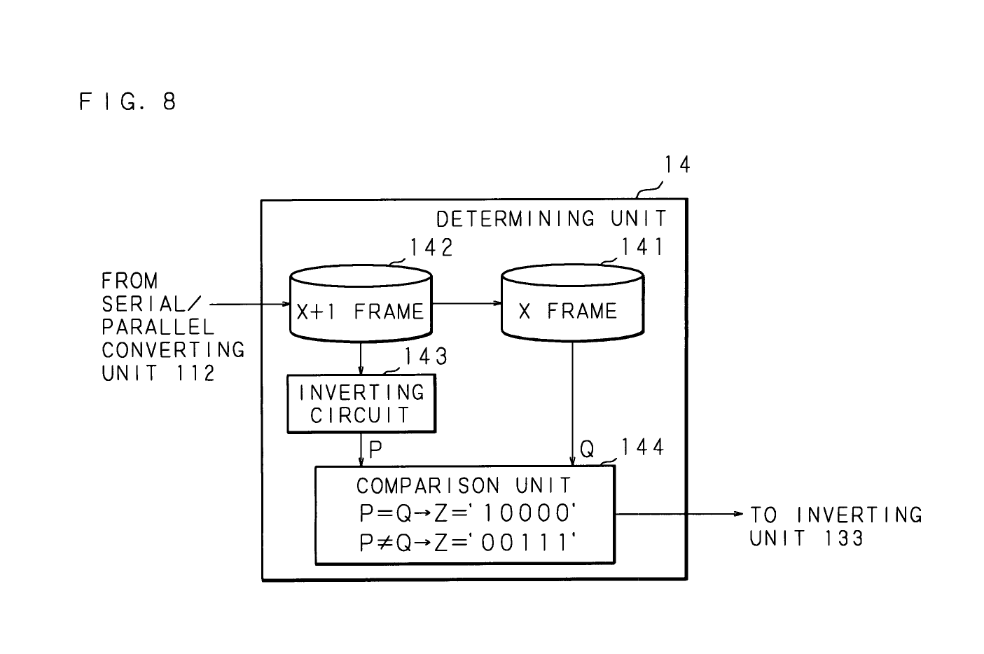

The determining unit 14 compares received data of an X frame with data of an X+1 frame and determines whether the data of the X frame matches data obtained by inverting bits of the subsequent data of the X+1 frame and then determines whether to transmit the data temporarily stored in the latch unit 113 and whether to invert bits of data in the inverting unit 133. FIG. 8 is a block diagram showing the configuration of the determining unit 14.

The determining unit 14 temporarily stores data Q of an X frame in the first memory 141. Then, the determining unit 14 receives subsequent data of an X+1 frame and temporarily stores the data of the X+1 frame in the second memory 142. Then, the inverting circuit 143 invert bits of data of the X+1 frame. The comparison circuit 144 determines whether data P obtained by inverting bits of data of the X+1 frame matches the data Q of the X frame. When the data P matches the data Q, the determining unit 14 transmits a “CLOSE” signal to the latch unit 113, sets an inverse bit Z to “10000” which instructs to invert bits of data, and transmits the inverse bit Z of 10000 to the inverting unit 133. Note that the data of the X frame and the data of the X+1 frame are not limited to ones to be temporarily stored in the determining unit 14.

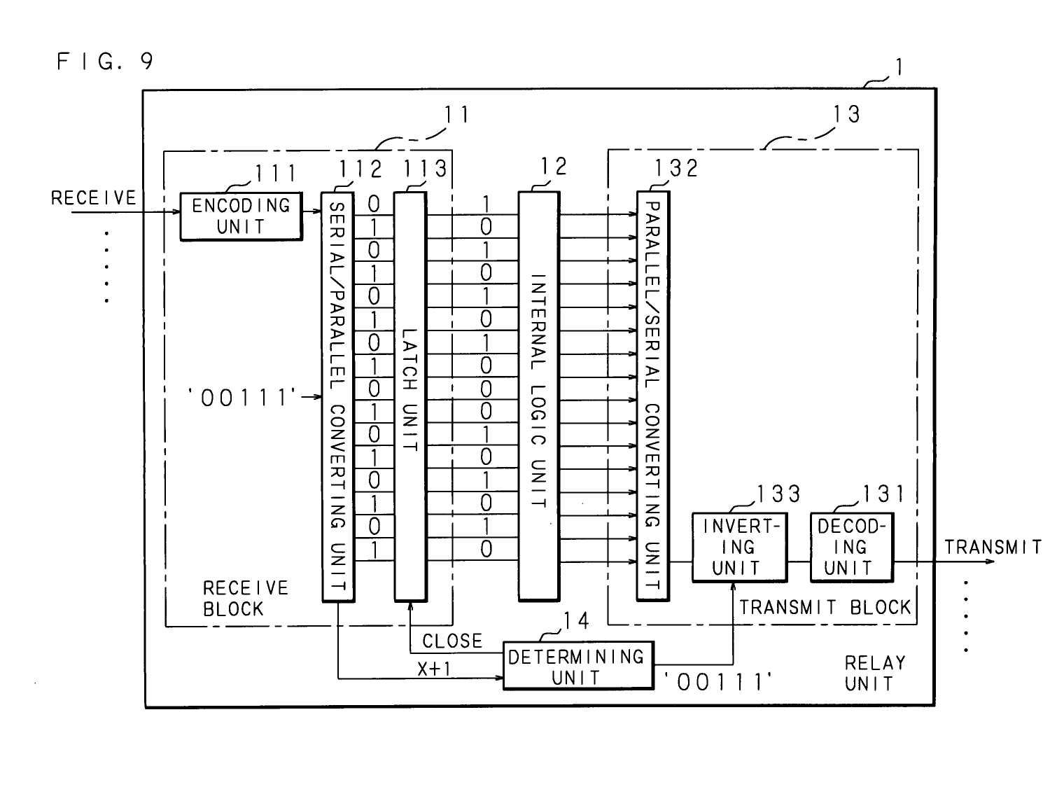

When the data P does not match the data Q, the determining unit 14 identifies unmatched bit locations (“00111” in the present embodiment), transmits an “OPEN” signal to the latch unit 113, sets the inverse bit Z to “00111” which indicates the bit locations not inverted, and transmits the inverse bit Z of 00111 to the inverting unit 133. FIG. 9 is a block diagram showing the operation of the relay unit 1 performed when the data P matches the data Q.

As shown in FIG. 9, when, while received data of the X frame is “5555”, received data of the X+1 frame is “AA2A”, the determining unit 14 determines that an inversion is not performed only on the bit locations of “00111” where the data P does not match the data Q. The determining unit 14 thus transmits a “CLOSE” signal to the latch unit 113, sets the inverse bit Z to “00111” which indicates the bit locations not inverted, and transmits the inverse bit Z of 00111 to the inverting unit 133. Accordingly, the received data of the X+1 frame is not transmitted to the internal logic unit 12 and the received data of the X frame is transmitted to the internal logic unit 12. After a predetermined arithmetic operation is performed on the data of the X frame, the data is terminated into serial data by the parallel/serial converting unit 132. The inverting unit 133 inverts bits of the terminated serial data except the specified bits and the decoding unit 131 decodes the bit-inverted serial data and then transmits the decoded serial data to external devices.

As such, even when it is verified, as a result of comparing received data of the X frame with received data of the X+1 frame, that some bits are inverted, without the occurrence of simultaneous switching, a process in the internal logic unit 12 is performed and only those bits (5 bits) that specify bit locations not inverted are transmitted to the inverting unit 133. Thus, as compared with the case in which inverse 15-bit data is transmitted with the latch being open, the amount of the memory used can be reduced, making it possible to reduce power consumption. Note that although the aforementioned embodiment is described using an example in which, when a determination is made as to whether data of the X frame matches data obtained by inverting bits of data of the X+1 frame, there is only one matching bit among 16 bits, the number of matching bits is not limited to only one bit; as long as the number of bits is the number by which the number of bits to be transferred can be reduced, there may be a plurality of matching bits.

As described above, according to the second embodiment, even when subsequent data, some of whose bits are inverted, is received, without many buses being switched simultaneously, it is sufficient to transmit to the transmit block a signal instructing to invert bits of data, e.g., a signal indicating bit locations not inverted, after a predetermined process is performed. Accordingly, while the amount of the memory used is reduced, the received data can be transferred to external devices. In addition, since there are only a few buses where the concurrent reading and writing from/to the memory occur, the increase in current can be reduced and malfunction of the device due to impulse noise does not occur, making it possible to ensure stable operation of the device.

### Third Embodiment

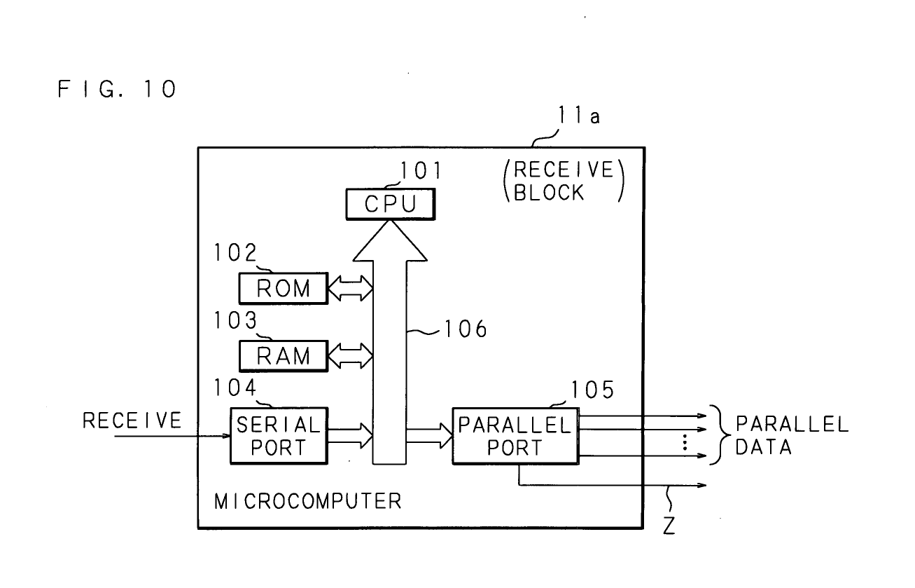

A relay unit 1 according to a third embodiment of the present invention will be described in detail below with reference to the drawings. The third embodiment is characterized in that the relay unit 1 according to the first embodiment is embodied by control by software. FIG. 10 is a block diagram showing the configuration of a microcomputer 11a that composes the receive block 11 of the relay unit 1 according to the third embodiment of the present invention.

The microcomputer 11a includes at least a CPU 101, a ROM 102, a RAM 103, a serial port 104, and a parallel port 105. The CPU 101 is connected to the aforementioned hardware components of the microcomputer 11a through an internal bus 106. The CPU 101 controls the hardware components and performs various software functions according to a computer program stored in the ROM 102.

The RAM 103 is composed of an SRAM, a flash memory, or the like, and stores temporary data which is generated upon the execution of the computer program. The serial port 104 is connected to the internal bus 106. By the serial port 104 being connected to a cable such as a LAN or WAN cable, the serial port 104 receives serial data to be transferred. The parallel port 105 is connected to the internal bus 106. The parallel port 105 transmits to the internal logic unit 12 parallel data into which the received serial data is converted into parallel data. In addition, the parallel port 105 transmits an inverse bit Z which indicates whether to invert bits of data or indicates bit locations not inverted, to a microcomputer 13a composing the transmit block 13.

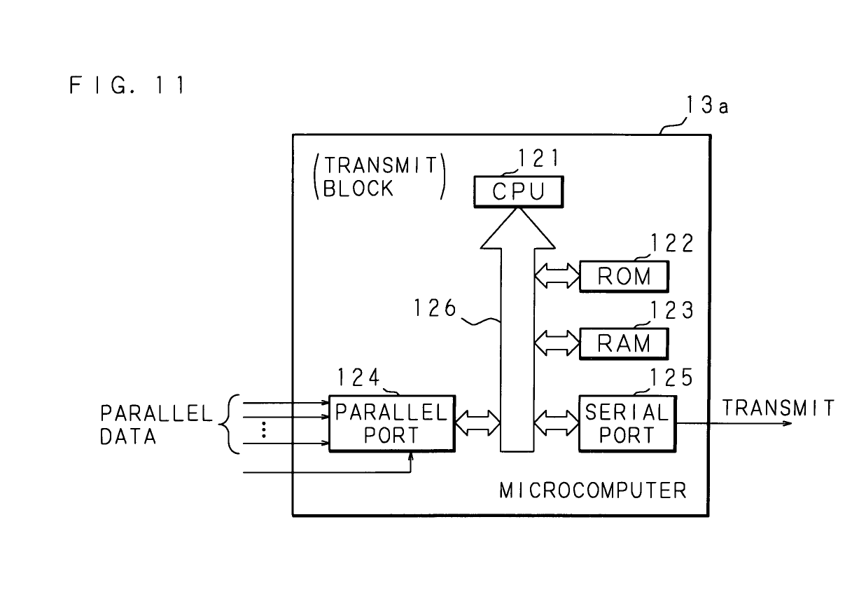

FIG. 11 is a block diagram showing the configuration of the microcomputer 13a that composes the transmit block 13 of the relay unit 1 according to the third embodiment of the present invention. The microcomputer 13a includes at least a CPU 121, a ROM 122, a RAM 123, a parallel port 124, and a serial port 125. The CPU 121 is connected to the aforementioned hardware components of the microcomputer 13a through an internal bus 126. The CPU 121 controls the hardware components and performs various software functions according to a computer program stored in the ROM 122.

The RAM 123 is composed of an SRAM, a flash memory, or the like, and stores temporary data which is generated upon the execution of the computer program. The parallel port 124 is connected to the internal bus 126. The parallel port 124 receives the parallel data processed by the internal logic unit 12, and receives from the microcomputer 11a composing the receive block 11 the inverse bit Z which indicates whether to invert bits of data or indicates bit locations not inverted. The serial port 125 is connected to the internal bus 126. By the serial port 125 being connected to a cable such as a LAN or WAN cable, the serial port 125 transfers to external devices serial data into which the received parallel data is converted into serial data and terminated.

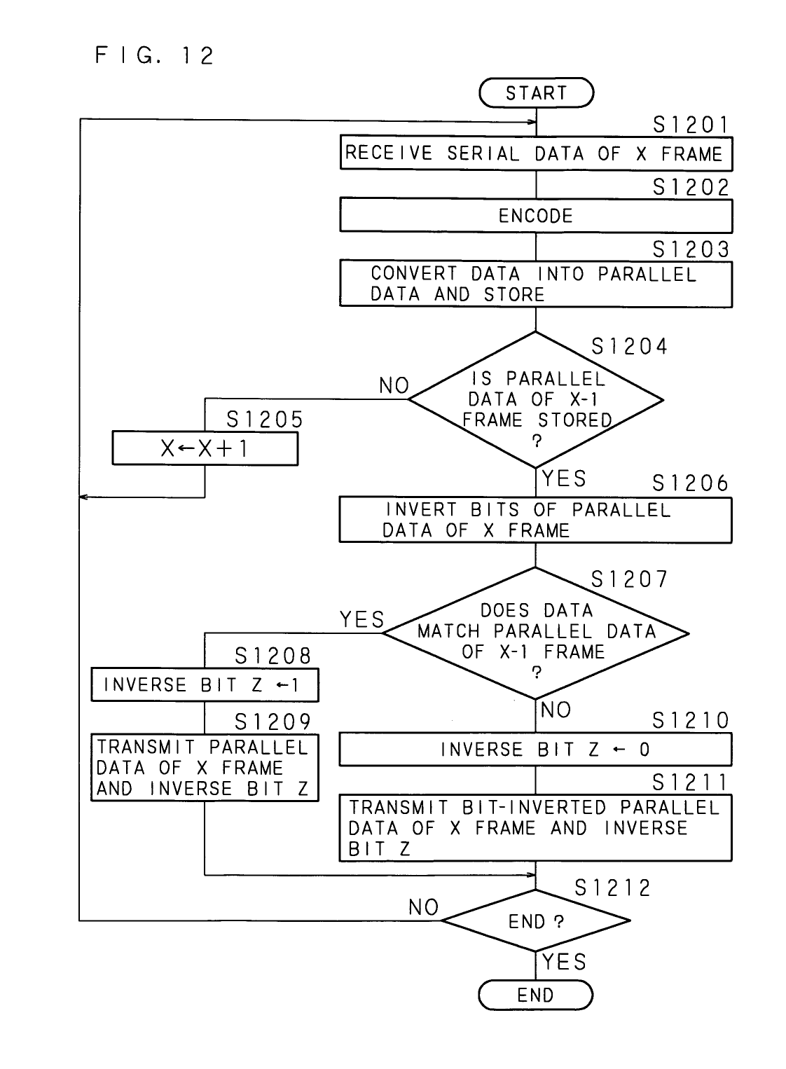

FIG. 12 is a flowchart showing the processing steps of the CPU 101 of the microcomputer 11a that composes the receive block 11 of the relay unit 1 according to the third embodiment of the present invention. The CPU 101 of the microcomputer 11a receives serial data of an X frame from the serial port 104 (step S1201), encodes (scrambles) the received serial data (step S1202), and then converts the encoded serial data into parallel data and stores the parallel data in the RAM 103 (step S1203).

The CPU 101 determines whether parallel data of a previous frame, i.e., parallel data of an X−1 frame, is stored in the RAM 103 (step S1204). If the CPU 101 determines that the parallel data of the X−1 frame is not stored in the RAM 103 (“NO” at step S1204), the CPU 101 receives data of an X+1 frame which is a subsequent frame (steps S1205 and S1201). If the CPU 101 determines that the parallel data of the X−1 frame is stored in the RAM 103 (“YES” at step S1204), the CPU 101 invert bits of the parallel data of the X frame and stores the bit-inverted parallel data of the X frame in the RAM 103 (step S1206). The CPU 101 determines whether the stored bit-inverted parallel data of the X frame matches the parallel data of the X−1 frame (step S1207).

If the CPU 101 determines that the stored bit-inverted parallel data of the X frame matches the parallel data of the X−1 frame (“YES” at step S1207); the CPU 101 sets an inverse bit Z to “1” (step S1208) and transmits the parallel data of the X frame stored in the RAM 103 and the inverse bit Z (step S1209). If the CPU 101 determines that the stored bit-inverted parallel data of the X frame does not match the parallel data of the X−1 frame (“NO” at step S1207), the CPU 101 sets the inverse bit Z to “0” (step S1210) and transmits the bit-inverted parallel data of the X frame and the inverse bit Z (step S1211).

The CPU 101 determines whether to end the processing (step S1212). If the CPU 101 determines not to end the processing (“NO” at step S1212), the CPU 101 returns the processing to step S1201 and repeats the aforementioned processes. If the CPU 101 determines to end the processing (“YES” at step S1212), the CPU 101 ends the processing.

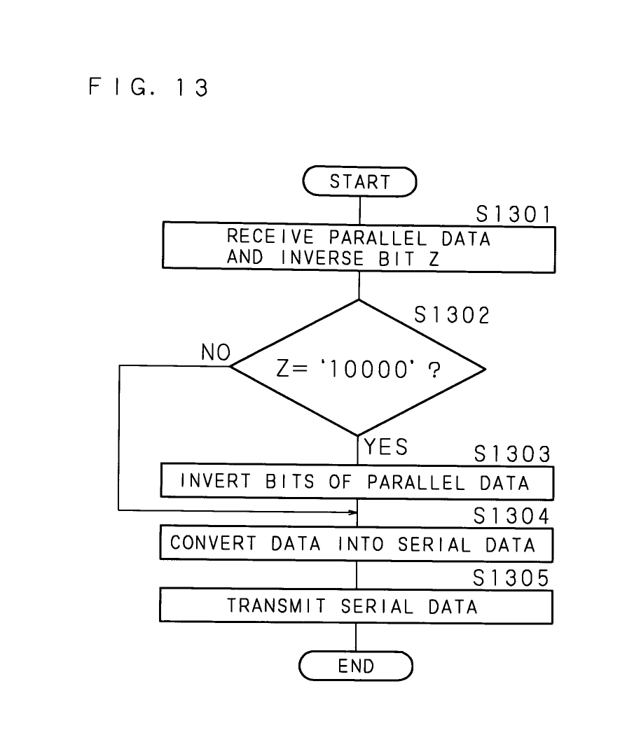

FIG. 13 is a flowchart showing the processing steps of the CPU 121 of the microcomputer 13a that composes the transmit block 13 of the relay unit 1 according to the third embodiment of the present invention. The CPU 121 of the microcomputer 13a receives parallel data and an inverse bit Z from the receive block 11 (step S1301) and determines whether the inverse bit Z is “1” (step S1302).

If the CPU 121 determines that the inverse bit Z is “1” (“YES” at step S1302), the CPU 121 invert bits of the received parallel data (step S1303). If the CPU 121 determines that the inverse bit Z is “0” (“NO” at step S1302), the CPU 121 skips step S1303 and converts the parallel data into serial data (step S1304) and then transmits the serial data to external devices (step S1305).

As described above, according to the third embodiment, when bit-inverted subsequent data (data of the X+1 frame) is received, without parallel data being switched simultaneously, it is sufficient to transmit to the transmit block 13 only a signal instructing to invert bits of data, e.g., an inverse bit (1 bit), after a predetermined process is performed. Accordingly, without using a large amount of the memory, the received data can be transferred to external devices. In addition, since simultaneous switching does not occur and thus there is no possibility of concurrent reading and writing from/to the memory, malfunction of the device due to impulse noise caused by a sudden increase in current does not occur, making it possible to ensure stable operation of the device.

### Fourth Embodiment

A relay unit 1 according to a fourth embodiment of the present invention will be described in detail below with reference to the drawings. The fourth embodiment is characterized in that the relay unit 1 according to the second embodiment is embodied by control by software. Note that since the configuration of the microcomputer 11a composing the receive block 11 and the configuration of the microcomputer 13a composing the transmit block 13 of the relay unit 1 according to the fourth embodiment of the present invention are the same as those described in the third embodiment, the components are denoted by the same reference numerals and the detailed description thereof is omitted.

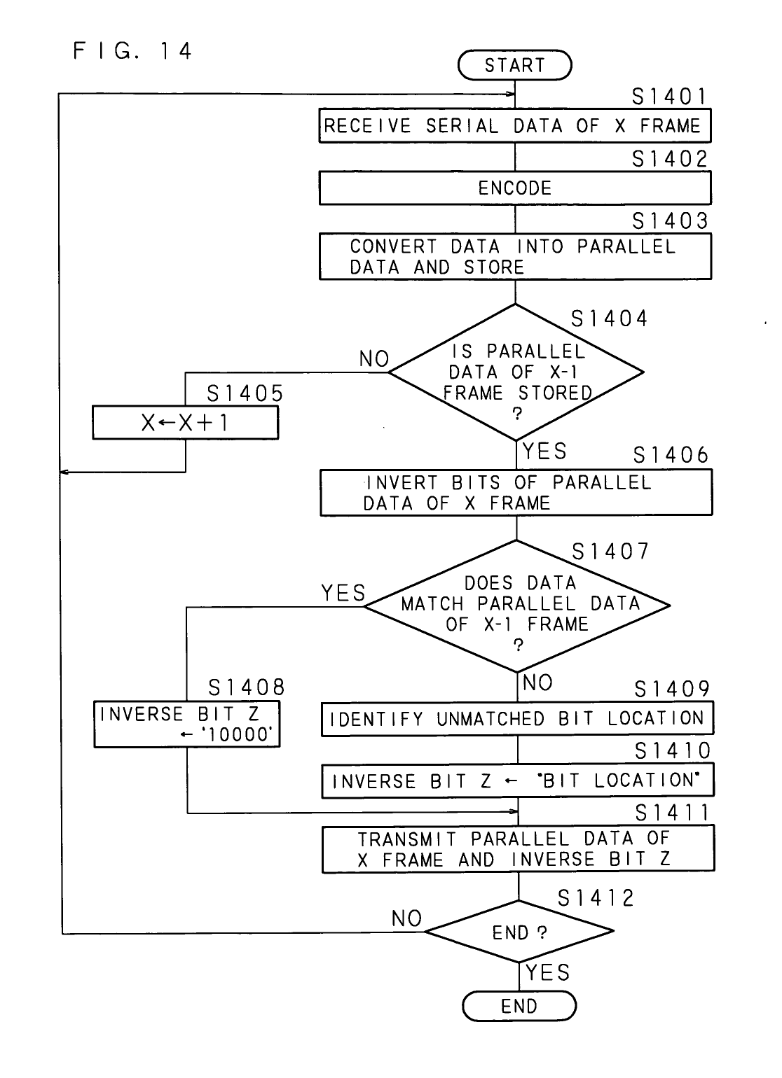

FIG. 14 is a flowchart showing the processing steps of the CPU 101 of the microcomputer 11a that composes the receive block 11 of the relay unit 1 according to the fourth embodiment of the present invention. The CPU 101 of the microcomputer 11a receives serial data of an X frame from the serial port 104 (step S1401), encodes (scrambles) the received serial data (step S1402), and then converts the encoded serial data into parallel data and stores the parallel data in the RAM 103 (step S1403).

The CPU 101 determines whether parallel data of a previous frame, i.e., parallel data of an X−1 frame, is stored in the RAM 103 (step S1404). If the CPU 101 determines that the parallel data of the X−1 frame is not stored in the RAM 103 (“NO” at step S1404), the CPU 101 receives data of an X+1 frame which is a subsequent frame (steps S1405 and S1401). If the CPU 101 determines that the parallel data of the X−1 frame is stored in the RAM 103 (“YES” at step S1404), the CPU 101 invert bits of the parallel data of the X frame (step S1406) and determines whether the bit-inverted parallel data of the X frame matches the parallel data of the X−1 frame (step S1407).

If the CPU 101 determines that the bit-inverted parallel data of the X frame matches the parallel data of the X−1 frame (“YES” at step S1407), the CPU 101 sets an inverse bit Z to “10000” (step S1408) and transmits the parallel data of the X frame stored in the RAM 103 and the inverse bit Z to the internal logic unit 12 (step S1411). If the CPU 101 determines that the bit-inverted parallel data of the X frame does not match the parallel data of the X−1 frame (“NO” at step S1407), the CPU 101 identifies unmatched bit locations (step S1409) and sets the inverse bit Z to the unmatched bit locations, e.g., “00111”, (step S1410) and then transmits the parallel data of the X frame and the inverse bit Z (step S1411).

The CPU 101 determines whether to end the processing (step S1412). If the CPU 101 determines not to end the processing (“NO” at step S1412), the CPU 101 returns the processing to step S1401 and repeats the aforementioned processes. If the CPU 101 determines to end the processing (“YES” at step S1412), the CPU 101 ends the processing.

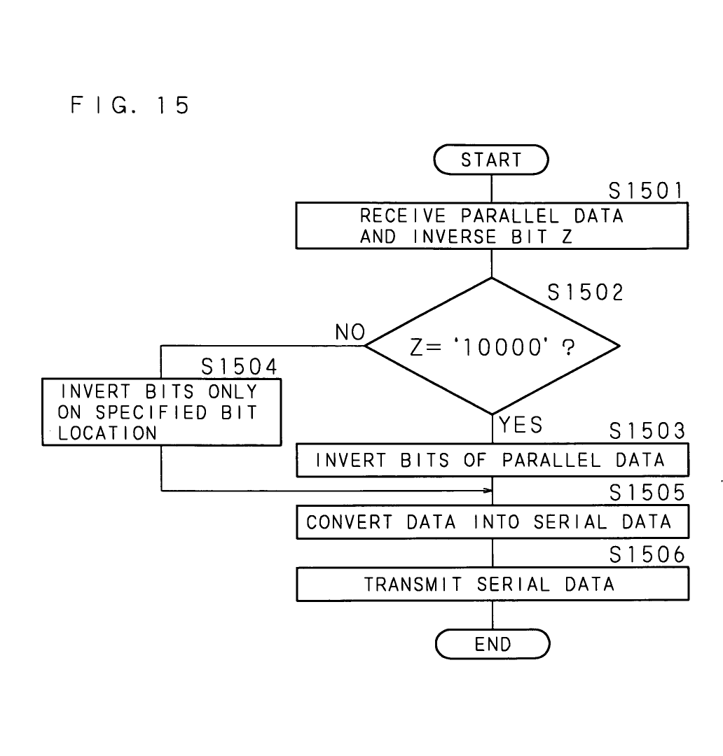

FIG. 15 is a flowchart showing the processing steps of the CPU 121 of the microcomputer 13a that composes the transmit block 13 of the relay unit 1 according to the fourth embodiment of the present invention. The CPU 121 of the microcomputer 13a receives parallel data and an inverse bit Z from the receive block 11 (step S1501) and determines whether the inverse bit Z is “10000” (step S1502).

If the CPU 121 determines that the inverse bit Z is “10000” (“YES” at step S1502), the CPU 121 inverts bits of the received parallel data (step S1503). If the CPU 121 determines that the inverse bit Z is not “10000” (“NO” at step S1502), the CPU 121 inverts bits of data only on bit locations specified by the inverse bit Z, e.g., “00111”, (step S1504); converts the parallel data into serial data (step S1505), and then transmits the serial data to external devices (step S1506).

As described above, according to the fourth embodiment, even when subsequent data, some of whose bits are inverted, is received, without the occurrence of simultaneous switching, it is sufficient to transmit to the transmit block 13 a signal instructing to invert bits of data, e.g., a signal indicating bit locations not inverted, after a predetermined process is performed. Accordingly, while the amount of the memory used is reduced, the received data can be transferred to external devices. In addition, since there are only a few buses where the concurrent reading and writing from/to the memory occur, the increase in current can be reduced and malfunction of the device due to impulse noise does not occur, making it possible to ensure stable operation of the device.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A relay unit which encodes data received frame by frame, converts the encoded data into parallel data, performs a predetermined process on the converted parallel data, converts the parallel data into serial data having been subjected to the predetermined process, decodes the converted serial data, and transmits the decoded serial data to external devices, comprising:
a latch unit that temporarily stores, frame by frame, converted parallel data;
a determining unit that compares received data with subsequent data to be received subsequently and thereby determines whether to invert bits of data; and
an inverting unit that invert bits of converted serial data, wherein
the determining unit comprises:
means for determining whether data obtained by inverting bits of the received converted parallel data is received as subsequent data;
means for transmitting, in case for determining that the data is received as subsequent data, a signal instructing to prohibit from storing temporarily the received subsequent data, to the latch unit; and
means for transmitting to the inverting unit a signal instructing to invert bits of data.

2. The relay unit according to claim 1, wherein
the determining unit further comprises:
means for determining whether data obtained by inverting bits of part of the received converted parallel data is received as subsequent data;
means for transmitting, in case for determining that the data is received as subsequent data, a signal instructing to prohibit from storing temporarily the received subsequent data, to the latch unit; and
means for transmitting to the inverting unit a signal instructing to invert a bit which has not been inverted and to prohibit from inverting other bits.

3. The relay unit according to claim 1, wherein
the determining unit further comprises:
means for temporarily storing the received converted parallel data and the subsequent converted parallel data received subsequently.

4. The relay unit according to claim 2, wherein
the determining unit further comprises:
means for temporarily storing the received converted parallel data and the subsequent converted parallel data received subsequently.

5. A relay unit that encodes data received frame by frame, converts the encoded data into parallel data, performs a predetermined process on the converted parallel data, converts the parallel data into serial data having been subjected to the predetermined process, decodes the converted serial data, and transmits the decoded serial data to external devices, comprising:
a latch unit that temporarily stores, frame by frame, converted parallel data;
a determining unit that compares received data with subsequent data to be received subsequently and thereby determines whether to invert bits of data; and
an inverting unit that invert bits of converted serial data, wherein
the determining unit comprises a processor capable of performing steps of
determining whether data obtained by inverting bits of the received converted parallel data is received as subsequent data;
transmitting, in case for determining to be received as subsequent data, a signal instructing to prohibit from storing temporarily the received subsequent data, to the latch unit; and
transmitting to the inverting unit a signal instructing to invert bits of data.

6. The relay unit according to claim 5, wherein
the determining unit comprises the processor further capable of performing steps of:
determining whether data obtained by invert bits of part of the received converted parallel data is received as subsequent data;
transmitting, in case for determining to be received as subsequent data, a signal instructing to prohibit from storing temporarily the received subsequent data, to the latch unit; and
transmitting to the inverting unit a signal instructing to invert a bit which has not been inverted and to prohibit from inverting other bits.

7. The relay unit according to claim 5, wherein
the determining unit comprises the processor further capable of performing a step of:
temporarily storing the received converted parallel data and the subsequent converted parallel data received subsequently.

8. The relay unit according to claim 6, wherein
the determining unit comprises the processor further capable of performing a step of:
temporarily storing the received converted parallel data and the subsequent converted parallel data received subsequently.

9. A computer memory product storing a computer program for causing a computer to:
encode data received frame by frame;
convert the encoded data into parallel data and perform a predetermined process on the converted parallel data;
convert the parallel data into serial data having been subjected to the predetermined process; and
decode the serial data and transmit the decoded serial data to external devices, wherein
the computer program comprising the steps of
causing the computer to temporarily store, frame by frame, converted parallel data;
causing the computer to determine whether data obtained by inverting bits of the received converted parallel data is received as subsequent data; and
causing the computer to convert into serial data, in case for determining to be received as subsequent data, the received subsequent data without temporarily storing the received subsequent data and then to invert bits of data.

10. The computer memory product storing a computer program according to claim 9, the computer program further comprising the steps of:
causing the computer to determine whether data obtained by inverting bits of part of the received converted parallel data is received as subsequent data; and
causing the computer to transmit, in case for determining to be received as subsequent data, an instruction to convert the received subsequent data into serial data without temporarily storing the received subsequent data and then to invert a bit which has not been inverted and to prohibit from inverting other bits.
